(19) United States
(12) Patent Application Publication
(10) Pub. No.: US 2011/0159860 A1
(43) Pub. Date: Jun. 30, 2011

(54) METHOD FOR MANAGING APPOINTMENTS IN A COMMUNICATION DEVICE

(75) Inventor: XIAN-PING ZHOU, Shenzhen City (CN)

(73) Assignees: SHENZHEN FUTAIHONG PRECISION INDUSTRY CO., LTD., ShenZhen City (CN); CHI MEI COMMUNICATION SYSTEMS, INC., Tu-Cheng City (TW)

(21) Appl. No.: 12/914,961

(22) Filed: Oct. 28, 2010

(30) Foreign Application Priority Data
Dec. 30, 2009 (CN) 200910312737.6

(51) Int. Cl. H04M 3/42

(52) U.S. Cl. 455/416; 455/414.1

(57) ABSTRACT

A method for managing appointments utilizes an appointment management system installed in a communication server between communication devices. The appointment management system receives a request list from one of the communication devices used by an originator. The request list is then saved in a database. The appointment management system invites the invitees to enter a video conference and prompts the invitees to input a departure location and date of an appointment. After the appointment management system receives a final venue and date determined by the originator. The appointment management system sends the final venue and date to all the invitees.

### BACKGROUND

1. Technical Field

Embodiments of the present disclosure relate to data sharing, and in particular, to a method for managing appointments among multiple communication devices.

2. Description of Related Art

The third generation (3G) communication network allows real-time video communication between two people. The 3 G communication network provides a fast transmission and broadband network, for users located in different places. However, schedule records in communication devices capable of communicating over the 3G network cannot automatically update to reflect appointments set during the video communication.

### BRIEF DESCRIPTION OF THE DRAWINGS

FIG. 1 is a schematic diagram of one embodiment of a communication server comprising an appointment management system and a database.

FIG. 2 is a flowchart illustrating one embodiment of an appointment management method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used herein, refers to logic embodied in hardware or firmware, or to a collection of software instructions, written in a programming language, such as, for example, Java, C, or Assembly. One or more software instructions in the module may be embedded in firmware, such as an EPROM. It will be appreciated that module may comprise connected logic units, such as gates and flip-flops, and may comprise programmable units, such as programmable gate arrays or processors. The module described herein may be implemented as either software and/or hardware module and may be stored in any type of computer-readable medium or other computer storage device.

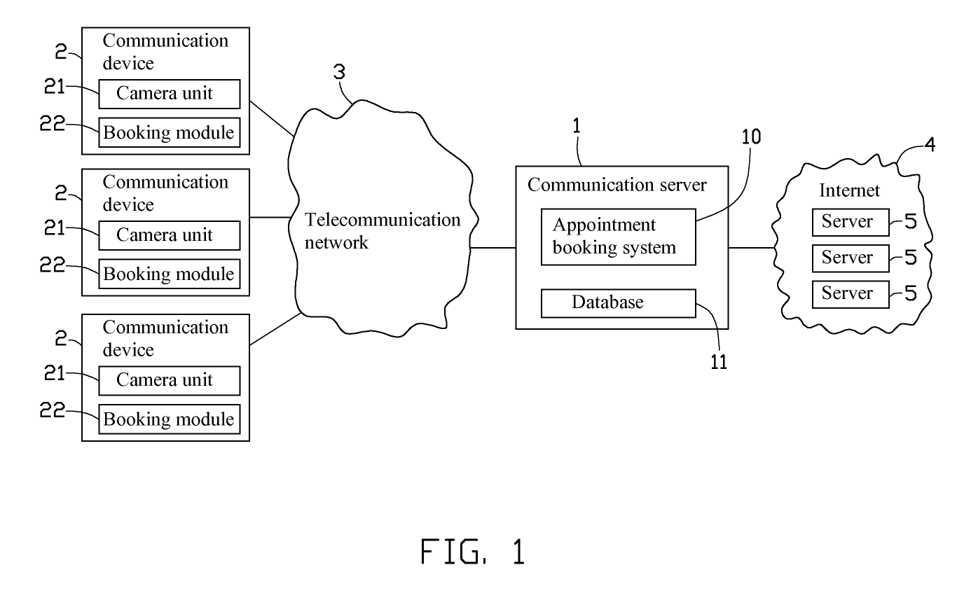

FIG. 1 is a schematic diagram of one embodiment of a communication server 1 comprising an appointment management system 10 and a database 11. The communication server 1 operates on a network, such as a telecommunication network 3 or the Internet 4. The appointment management system 10 can manage appointments among communication devices 2 in the telecommunication network 3 or the Internet 4. The communication server 1 electronically connects to servers 5 via the Internet 4. Depending on the embodiment, the communication devices 2 may include other communication devices, such as mobile phones, and personal digital assistants (PDAs) enabling wireless linking to the telecommunication network 3.

The appointment management system 10 and the communication devices 2 are generally controlled and coordinated by an operating system, such as UNIX, Linux, Windows 95, 98, NT, 2000, XP, Vista, Mac OS X. In addition, the communication devices 2 are generally controlled and coordinated by an embedded operating system, or any other compatible operating systems. In other embodiments, the communication devices 2 may be controlled by a proprietary operating system. Conventional operating systems control and schedule computer processes for execution, perform memory management, provide file system, networking, and I/O services, and provide a user interface, such as a graphical user interface (GUI), among other things.

The database 11 stores historical records of appointments of the communication devices 2, a request list transmitted from one of the communication devices 2 used by an originator and geographical information of the location database from the server 5. The originator is a person who sends invitations to invite invitees to join the appointment. The historical record includes information of time, invitees and venue of each appointment. The request list is a list of invitees to whom the originator wants to extend invitations to an appointment.

The server 5 includes a location database storing geographical information. The communication server 1 connects the server 5 via the Internet 4. In one embodiment, the communication server 1 can download geographical information from the location database of the server 5 to the database 11. For example, the location database can be an electronic map database in the Internet, such the GOOGLE Maps. In other embodiments, the communication server 1 can further access the location database of the server 5 via the Internet 4. The geographical information includes attribute map data, such as roads, buildings, rivers, and place-names. The geographical information further includes geographical coordinates of the data, such as conventional latitude, longitude, and altitude.

Each one of the communication devices 2 includes a management module 21 and at least one camera unit 22. The management module 21 connects the appointment management system 10 via the telecommunication network 3. The management module 21 is operable to invite invitees to the appointment by an originator and to send a response to the appointment management system 10 from an invitee upon detecting an invitation. In one embodiment, the management module 21 is operable to provide the originator with a user interface to determine which invitees have responded. In addition, the management module 21 further transmits the request list to the database 11. Depending on the embodiment, invitees can be added to the request list from an address book, a calling history, or direct phone number input on the communication devices 2.

The camera unit 22 provides a video camera function to the originator and invitees, making possible a video conference configuration for discussion of the appointment, in which all participants can view each other.

The appointment management system 10 operates in the communication server 1, which connects the with communication devices 2 via the telecommunication network 3. The appointment management system 10 receives the request list from the originator using one of the communication devices 2, and issues invitations to the communication devices 2 of the invitees. The invitations include a rejection, a notification mode acceptance, and a conference mode acceptance.

Depending on the embodiment, the appointment management system 10 issues an invitation to the communication devices 2 based on the request list. The invitation includes a choice of rejection, notice mode acceptance, or conference mode acceptance. For example, if the originator issues the invitation to the appointment management system 10 based on the request list, and communication devices 2 enable video function, the invitee can select conference mode acceptance as a response, and the appointment management system 10 invites the invitee to the video conference and requests a departure location and a venue selection. If the communication devices 2 enable video function but return a rejection, the appointment management system 10 sets the communication devices 2 in a notification mode. The appointment management system 10 does not send the message to the communication devices 2 to invite the invitees to the video conference, but issues a information to the communication devices 2 to notify the invitees.

The appointment management system 10 further calculates and issues evaluation information of the appointment to the communication devices 2. The originator and the invitees can see and discuss the evaluation information. The evaluation information include distances between the departure locations and the venues and required travel time to the venues from the departure locations. After the originator and invitees determine the information of the appointment, the originator issues the information to the appointment management system 10 by one of the communication devices 2. Finally, the appointment management system 10 issues the information to all communication devices 2 on the request list, even those in notice mode not participating in the video conference.

In other embodiments, if one of the communication devices 2 with video function disabled receives the invitation from the appointment management system 10, the invitee can select the notification mode as a response to the appointment management system 10. Then the appointment management system 10 only issues the information to the communication devices 2 to notify the invitees, such as a departure location, opening time and a venue selection of the appointment. In addition, the appointment management system 10 sets the communication devices 2 in a notification mode if no response is received from the communication devices 2.

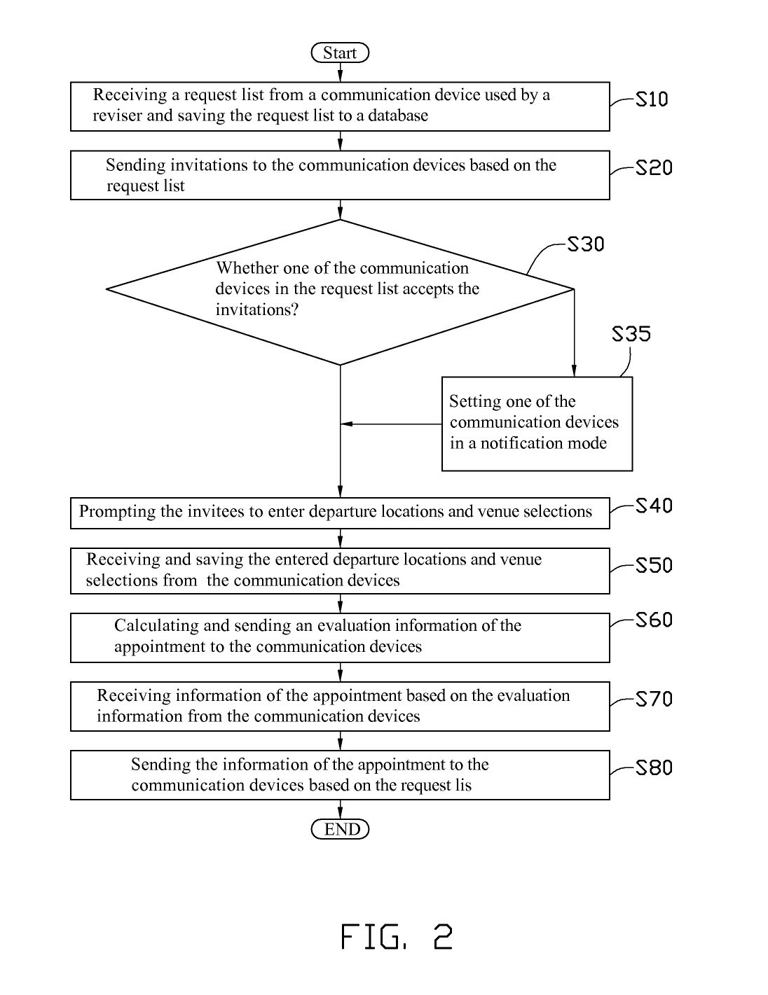

FIG. 2 is a flowchart illustrating an embodiment of a method of managing an appointment. Depending on the embodiment, additional blocks may be added, others deleted, and the ordering of the blocks may be changed.

In block S10, a request list is received from an originator using one of the communication devices 2 and is saved to the database 11. In one embodiment, the management module 21 is operable to provide the originator a user interface to determine which invitees to be invited.

In block S20, the appointment management system 10 issues invitations to communication devices 2 based on the request list. The invitations include choice of rejection, notification mode acceptance, and conference mode acceptance.

In block S30, the appointment management system 10 determines whether one of the communication devices 2 submits conference mode acceptance. If so, block S40 is implemented. If not, block S35 is implemented and the appointment management system 10 sets the communication devices 2 in a notification mode.

In block S40, the appointment management system 10 prompts invitees to enter departure locations and venue selections.

In block S50, the appointment management system 10 receives the departure locations and the venue selections from the communication devices 2 and saves the received information to the database 11.

In block S60, the appointment management system 10 calculates distances between the departure locations and the venues and required travel time to the venues from the departure locations, and issues the results to the communication devices 2.

In block S70, the appointment management system 10 receives the determined venue information based on the calculated distances and the required travel time from the communication devices 2.

In block S80, the appointment management system 10 issues the determined venue information to the communication devices 2.

It should be emphasized that the described inventive embodiments are merely possible examples of implementations, and set forth for a clear understanding of the principles of the present disclosure. Many variations and modifications may be made to the above-described inventive embodiments without departing substantially from the spirit and principles of the present disclosure. All such modifications and variations are intended to be comprised herein within the scope of this disclosure and the above-described inventive embodiments, and the present disclosure is protected by the following claims.

What is claimed is:

1. A method for managing an appointment between communication devices and a communication server operated in a telecommunication network, the communication server comprising a database and an appointment management system, the method comprising:
receiving a request list from one of the communication devices used by an originator and saving the request list to the database;
sending invitations to the communication devices based on the request list to invite invitees to the appointment;
determining whether one of the communication devices in the request list accepts the invitations from the appointment management system;
prompting the invitees to enter departure locations and venue selections upon receipt of at least one acceptance from the communication devices;
receiving the entered departure locations and venue selections from the communication devices and saving the received information to the database;
calculating and sending an evaluation of the appointment to the communication devices;
receiving information of the appointment based on the evaluation information from the communication devices; and
sending the information of the appointment to the communication devices based on the request list.

2. The method of claim 1, wherein the communication devices are mobile phones.

3. The method of claim 1, further comprising setting one of the communication devices in a notification mode if no response is received therefrom.

4. The method of claim 1, further comprising setting one of the communication devices in a notification mode upon determination that one of the communication devices has rejected the invitation.

5. The method of claim 1, wherein the evaluation information includes distances between the departure locations and the venues, and travel time to the venues from the departure locations calculated by the appointment management system.

6. The method of claim 1, wherein the invitations include a choice of rejection, a notification mode acceptance, and a conference mode acceptance.

7. A storage medium having stored thereon instructions that, when executed by a processor, cause the processor to perform a method for managing an appointment between communication devices in a telecommunication network, the method comprising:
receiving a request list from one of the communication devices used by an originator and saving the request list to a database;
sending invitations to the communication devices based on the request list to invite invitees to the appointment;
determining whether one of the communication devices in the request list accepts the invitation from the appointment management system;
prompting the invitees to enter a departure location and venue selection upon receipt of at least one acceptance from the communication devices;
receiving the entered information of the departure location and venue selection from the communication devices and save the received information to the database;
calculating and sending evaluation information of the appointment to the communication devices;
receiving information of the appointment based on the evaluation information from the communication devices; and
sending the information of the appointment to the communication devices based on the request list.

8. The storage medium of claim 7, wherein the communications are mobile phones.

9. The storage medium of claim 7, wherein the method further comprises setting one of the communication devices in a notification mode if no response is received therefrom.

10. The storage medium of claim 7, wherein the method further comprises setting one of the communication devices in a notification mode upon determination that one of the communication devices has rejected the invitation.

11. The storage medium of claim 7, wherein the evaluation information include distances between the departure locations and the venues and required travel time to the venues from the departure locations calculated by the appointment management system.

12. The storage medium of claim 7, wherein the invitations include a choice of rejection, a notification mode acceptance, and a conference mode acceptance.
